(19) United States
(12) Patent Application Publication
(10) Pub. No.: US 2020/0372813 A1
(43) Pub. Date: Nov. 26, 2020

(54) METHOD AND SYSTEM FOR RE-ACTIVATING A FLIGHT PLAN

(71) Applicant: HONEYWELL INTERNATIONAL INC., Morris Plains, NJ (US)

(72) Inventors: Steven L. Smith, Surprise, AZ (US); Susan McCullough, Phoenix, AZ (US); Keshav Rao, Phoenix, AZ (US)

(73) Assignee: HONEYWELL INTERNATIONAL INC., Morris Plains, NJ (US)

(21) Appl. No.: 16/417,235

(22) Filed: May 20, 2019

(51) Int. Cl. G08G 5/00

(52) U.S. Cl. CPC G08G 5/0039; G08G 5/0013

(57) ABSTRACT

Methods and systems are provided for recovering flight plan data for a bypassed segment of a flight plan aircraft. The method comprises loading an initial flight plan onto a Flight Management System (FMS) that is located on board the aircraft. The active flight plan includes multiple waypoints located along the active flight plan. A modified flight plan is created and executed that bypasses at least one of the waypoints located along the initial flight plan. The bypassed flight data is stored in the memory of the FMS. A restored flight plan is created later by retrieving the bypassed flight data from the FMS memory and loaded onto the FMS. The restored flight plan is then executed by the FMS.

### TECHNICAL FIELD

The present invention generally relates to aircraft operations, and more particularly relates to a method and system for re-activating a flight plan.

### BACKGROUND

During a flight, an aircraft may be cleared by ATC (Air Traffic Control) to take a shortcut to a downpath waypoint of the flight plan and then may be later assigned by ATC to return to the plan as filed. This assignment may be to an arbitrary portion of the flight plan and the crew is expected to comply with the ATC instructions. However, a lack of information about the bypassed portion of the initial flight plan complicates the process of recalling the bypassed portion of the flight plan. Hence, there is a need for a method and system for re-activating a flight plan.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A method is provided for recovering flight plan data for a bypassed segment of a flight plan onboard an aircraft. The method comprises: loading an initial flight plan onto a Flight Management System (FMS) located on board the aircraft, where the active flight plan comprises multiple waypoints located along the active flight plan; creating a modified flight plan that bypasses at least one of the waypoints located along the initial flight plan; storing bypassed flight data that contains the bypassed waypoints located along the initial flight plan, where the bypassed flight data is stored in a retrievable electronic memory located on the FMS; executing the modified flight plan with the FMS; creating a restored flight plan by retrieving the bypassed flight data from the retrievable electronic memory and loading the restored flight plan onto the FMS; and executing the restored flight plan with the FMS.

A system is provided for recovering flight plan data for a bypassed segment of a flight plan on board an aircraft. The system comprises: a navigation system located on board the aircraft, where the navigation system has a processor and a retrievable electronic memory, where the processor is programmed to, load an initial flight plan into the navigation system located comprising multiple waypoints located along the initial flight plan, create a modified flight plan that bypasses at least one of the waypoints located along the initial flight plan, store bypassed flight data that contains the bypassed waypoints located along the initial flight plan in a retrievable electronic memory located on the navigation system, execute the modified flight plan, create a restored flight plan by retrieving the bypassed flight data from the retrievable electronic memory, load the restored flight plan onto the navigation system, and execute the restored flight plan; and a visual data system that displays the restored flight plan and the modified flight plan.

Furthermore, other desirable features and characteristics of the method and system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 shows a diagram of an in-flight aircraft that contains an onboard flight management system (FMS) along with a visual data system in accordance with one embodiment;

FIG. 2 shows a block diagram of a visual data system in accordance with one embodiment;

FIG. 3 shows a diagram of parts of a standard flight plan in accordance with one embodiment;

FIG. 4 shows a visual display of a standard flight plan in accordance with one embodiment;

FIG. 5 shows a display of a flight plan with multiple waypoints in accordance with one embodiment;

FIG. 6 shows a display of a flight plan with a highlighted current segment in accordance with one embodiment;

FIG. 7 shows a display of a flight plan with flight operation that bypasses waypoints in accordance with one embodiment;

FIG. 8 shows a display of a flight plan with a modified flight plan and an overlay of a recovered bypass flight plan in accordance with one embodiment;

FIG. 9 shows a diagram of a selected heading with an intersection of a flight plan in accordance with one embodiment;

FIG. 10 shows a diagram of a recovered flight plan with an intercept of an added waypoint in accordance with one embodiment;

FIG. 11 shows an alternative diagram of a recovered flight plan with an intercept of an added waypoint in accordance as shown in FIG. 10 in accordance with one embodiment;

FIGS. 12A and 12B show diagrams of a recovered flight plan with a resumption without regard to the aircraft's present position; and

FIG. 13 shows a flowchart for a method for recovering flight plan data for a bypassed segment of a flight plan in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

A method and system for recovering flight plan data for bypassed segments of a flight plan on board an aircraft has been developed. The method involves loading an initial flight plan onto a flight management system (FMS). The initial flight plan comprises multiple look waypoints located along the flight plan. A modified flight plan is created later that bypasses at least one of the waypoints. Bypassed flight data that contains the bypassed waypoints located along the initial flight plan is stored in a retrievable electronic memory located on the FMS. The modified flight plan is then executed with the FMS. At a later point, a restored flight plan is created by retrieving the bypassed flight data from the memory of the FMS. The restored flight plan is loaded on to the FMS and then executed.

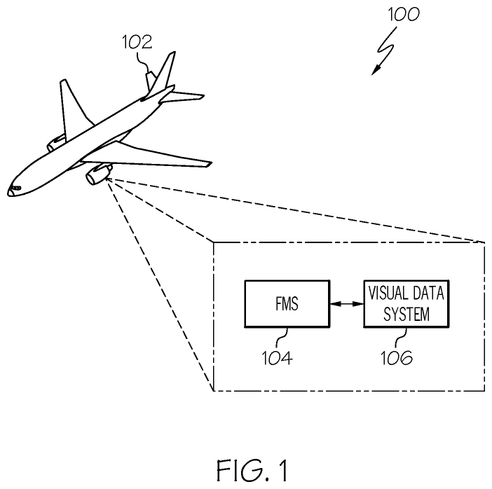

Turning now to FIG. 1, a diagram 100 is shown of an in-flight aircraft 102 that contains an onboard FMS 104 along with a visual data system 106 that is accessed by the FMS 104 in accordance with one embodiment. The FMS 104, as is generally known, is a specialized computer that automates a variety of in-flight tasks such as in-flight management of the flight plan. Using various sensors such as global positioning system (GPS), the FMS 104 determines the aircraft's position and guides the aircraft along its flight plan. From the cockpit, the FMS 104 is normally controlled through a device that is part of the visual display system 106 such as a control display unit (CDU) which incorporates a small screen, a keyboard or a touchscreen. The FMS 104 displays the flight plan and other critical flight data to the aircrew during operation.

The FMS 104 may have a built-in electronic memory system that contains a navigation database. The navigation database contains elements used for constructing a flight plan. In some embodiments, the navigation database may be separate from the FMS 104 and located onboard the aircraft while in other embodiments the navigation database may be located on the ground and relevant data provided to the FMS 104 via a communications link with a ground station. The navigation database used by the FMS 104 may typically include: waypoints/intersections; airways; radio navigation aids/navigation beacons; airports; runway; standard instrument departure (SID) information; standard terminal arrival (STAR) information; holding patterns; and instrument approach procedures. Additionally, other waypoints may also be manually defined by pilots along the route.

The flight plan is generally determined on the ground before departure by either the pilot or a dispatcher for the crew of the aircraft. It may be manually entered into the FMS 104 or selected from a library of common routes. In other embodiments the flight plan may be loaded via a communications data link from an airline dispatch center. During preflight planning, additional relevant aircraft performance data may be entered including information such as: gross aircraft weight; fuel weight and the center of gravity of the aircraft. The aircrew may use the FMS 104 to modify the plight flight plan before takeoff or even while in flight for variety of reasons. Such changes may be entered via the MCDU or other interface device. Once in flight, the principal task of the FMS 104 is to accurately monitor the aircraft's position and guide the aircraft along the intended route of flight. This may use a GPS, a VHF omnidirectional range (VOR) system, or other similar sensor in order to determine and validate the aircraft's exact position. The FMS 104 constantly cross checks among various sensors to determine the aircraft's position with accuracy. In alternative embodiments, other types of electronic navigation systems may be used in place of the FMS.

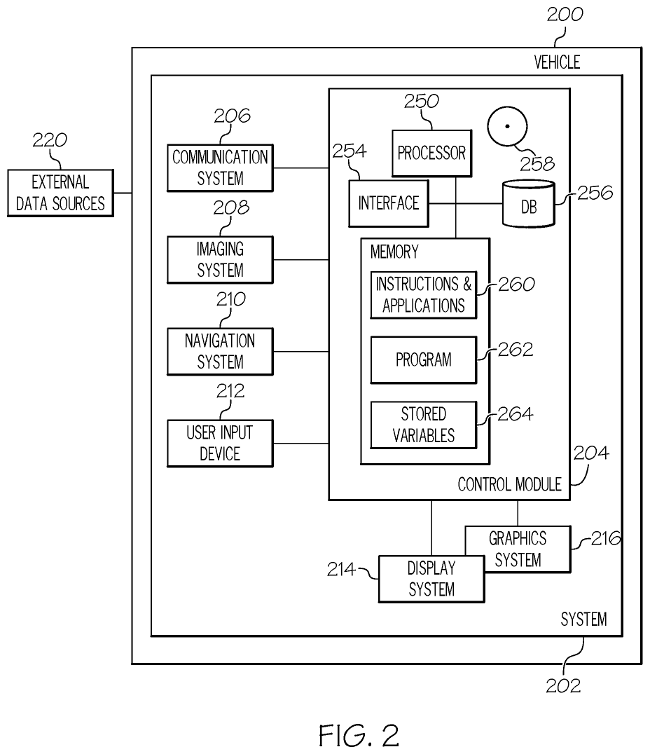

Turning now to FIG. 2, in the depicted embodiment, the visual data system 202 (shown as 106 in FIG. 1) includes: the control module 204 that is operationally coupled to a communication system 206, an imaging system 208, a navigation system 210, a user input device 212, a display system 214, and a graphics system 216. The operation of these functional blocks is described in more detail below. In the described embodiments, the depicted visual data system 202 is generally realized as an aircraft flight deck display system within a vehicle 200 that is an aircraft; however, the concepts presented here can be deployed in a variety of mobile platforms, such as land vehicles, spacecraft, watercraft, and the like. Accordingly, in various embodiments, the visual data system 202 may be associated with or form part of larger aircraft management system, such as an FMS 104 as depicted in FIG. 1.

In the illustrated embodiment, the control module 204 is coupled to the communications system 206, which is configured to support communications between external data source(s) 220 and the aircraft. External source(s) 220 may comprise air traffic control (ATC), or other suitable command centers and ground locations. In this regard, the communications system 206 may be realized using a radio communication system or another suitable data link system.

Navigation system 210 is configured to provide real-time navigational data and/or information regarding operation of the aircraft. The navigation system 210 may be realized as a global positioning system (GPS), inertial reference system (IRS), or a radio-based navigation system (e.g., VHF omni-directional radio range (VOR) or long range aid to navigation (LORAN)), and may include one or more navigational radios or other sensors suitably configured to support operation of the navigation system 210, as will be appreciated in the art. The navigation system 210 is capable of obtaining and/or determining the current or instantaneous position and location information of the aircraft (e.g., the current latitude and longitude) and the current altitude or above ground level for the aircraft. Additionally, in an exemplary embodiment, the navigation system 210 includes inertial reference sensors capable of obtaining or otherwise determining the attitude or orientation (e.g., the pitch, roll, and yaw, heading) of the aircraft relative to earth.

The user input device 212 is coupled to the control module 204, and the user input device 212 and the control module 204 are cooperatively configured to allow a user (e.g., a pilot, co-pilot, or crew member) to interact with the display system 214 and/or other elements of the visual data system 202 in a conventional manner. The user input device 212 may include any one, or combination, of various known user input device devices including, but not limited to: a touch sensitive screen; a cursor control device (CCD) (not shown), such as a mouse, a trackball, or joystick; a keyboard; one or more buttons, switches, or knobs; a voice input system; and a gesture recognition system. In embodiments using a touch sensitive screen, the user input device 212 may be integrated with a display device. Non-limiting examples of uses for the user input device 212 include: entering values for stored variables 264, loading or updating instructions and applications 260, and loading and updating the contents of the database 256, each described in more detail below.

In general, the display system 214 may include any device or apparatus suitable for displaying flight information or other data associated with operation of the aircraft in a format viewable by a user. Display methods include various types of computer generated symbols, text, and graphic information representing, for example, pitch, heading, flight path, airspeed, altitude, runway information, waypoints, targets, obstacle, terrain, and required navigation performance (RNP) data in an integrated, multi-color or monochrome form. In practice, the display system 214 may be part of, or include, a primary flight display (PFD) system, a panel-mounted head down display (HDD), a head up display (HUD), or a head mounted display system, such as a “near to eye display” system. The display system 214 may comprise display devices that provide three dimensional or two-dimensional images and may provide synthetic vision imaging. Non-limiting examples of such display devices include cathode ray tube (CRT) displays, and flat panel displays such as LCD (liquid crystal displays) and TFT (thin film transistor) displays. Accordingly, each display device responds to a communication protocol that is either two-dimensional or three, and may support the overlay of text, alphanumeric information, or visual symbology.

As mentioned, the control module 204 performs the functions of the visual data system 202 as shown as 106 in FIG. 1. With continued reference to FIG. 2, within the control module 204, the processor 250 and the memory 252 (having therein the program 262) form a processing engine that performs the described processing activities in accordance with the program 262, as is described in more detail below. The control module 204 generates display signals that command and control the display system 214.

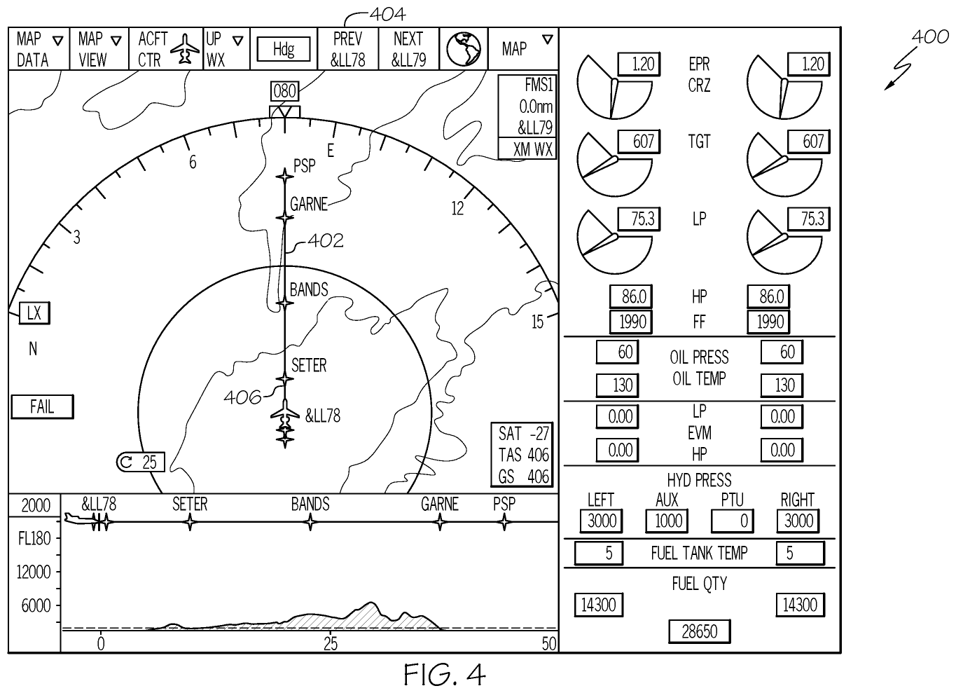

The control module 204 includes an interface 254, communicatively coupled to the processor 250 and memory 252 (via a bus 255), database 256, and an optional storage disk 258. In various embodiments, the control module 204 performs actions and other functions in accordance with steps of a method 400 described in connection with FIG. 4. The processor 250 may comprise any type of processor or multiple processors, single integrated circuits such as a microprocessor, or any suitable number of integrated circuit devices and/or circuit boards working in cooperation to carry out the described operations, tasks, and functions by manipulating electrical signals representing data bits at memory locations in the system memory, as well as other processing of signals.

The memory 252, the database 256, or a disk 258 maintain data bits and may be utilized by the processor 250 as both storage and a scratch pad. The memory locations where data bits are maintained are physical locations that have particular electrical, magnetic, optical, or organic properties corresponding to the data bits. The memory 252 can be any type of suitable computer readable storage medium. For example, the memory 252 may include various types of dynamic random access memory (DRAM) such as SDRAM, the various types of static RAM (SRAM), and the various types of non-volatile memory (PROM, EPROM, and flash). In certain examples, the memory 252 is located on and/or co-located on the same computer chip as the processor 250. In the depicted embodiment, the memory 252 stores the above-referenced instructions and applications 260 along with one or more configurable variables in stored variables 264. The database 256 and the disk 258 are computer readable storage media in the form of any suitable type of storage apparatus, including direct access storage devices such as hard disk drives, flash systems, floppy disk drives and optical disk drives. The database may include an airport database (comprising airport features) and a terrain database (comprising terrain features). In combination, the features from the airport database and the terrain database are referred to map features. Information in the database 256 may be organized and/or imported from an external source 220 during an initialization step of a process.

The bus 255 serves to transmit programs, data, status and other information or signals between the various components of the control module 204. The bus 255 can be any suitable physical or logical means of connecting computer systems and components. This includes, but is not limited to, direct hard-wired connections, fiber optics, infrared and wireless bus technologies.

The interface 254 enables communications within the control module 204, can include one or more network interfaces to communicate with other systems or components, and can be implemented using any suitable method and apparatus. For example, the interface 254 enables communication from a system driver and/or another computer system. In one embodiment, the interface 254 obtains data from external data source(s) 220 directly. The interface 254 may also include one or more network interfaces to communicate with technicians, and/or one or more storage interfaces to connect to storage apparatuses, such as the database 256.

It will be appreciated that the visual data system 202 may differ from the embodiment depicted in FIG. 2. As mentioned, the visual data system 202 can be integrated with an existing flight management system (FMS) 104 or aircraft flight deck display.

During operation, the processor 250 loads and executes one or more programs, algorithms and rules embodied as instructions and applications 260 contained within the memory 252 and, as such, controls the general operation of the control module 204 as well as the visual data system 202. In executing the process described herein, the processor 250 specifically loads and executes the novel program 262. Additionally, the processor 250 is configured to process received inputs (any combination of input from the communication system 206, the imaging system 208, the navigation system 210, and user input provided via user input device 212), reference the database 256 in accordance with the program 262, and generate display commands that command and control the display system 214 based thereon.

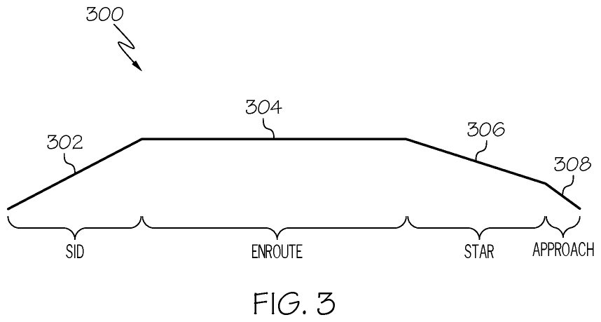

Turning now to FIG. 3, a diagram 300 of segments of a standard flight plan is shown in accordance with one embodiment. In this example, the initial segment of the flight plan may be a standard instrument departure (SID) 302 that takes the aircraft from the departure point to a cruising altitude. Once the cruising altitude is reached, the aircraft enters the “enroute” segment 304 of the flight plan. Upon nearing the destination, the aircraft begins the descent in the standard terminal arrival (STAR) segment 306 of the flight plan. The flight plan concludes with a final approach segment 308 that takes the aircraft to the final destination. Turning now to FIG. 4, an example of a visual display 400 of a standard flight plan is shown in accordance with one embodiment. In this example, a standard geographical map display 402 is shown overlaid with the flight plan 404 of the aircraft by a visual data system 106 and 202 as shown previously in FIGS. 1 and 2. The flight plan is divided into segments by waypoints. In this example, the current segment 406 being flown by the aircraft is highlighted for easy identification by a pilot.

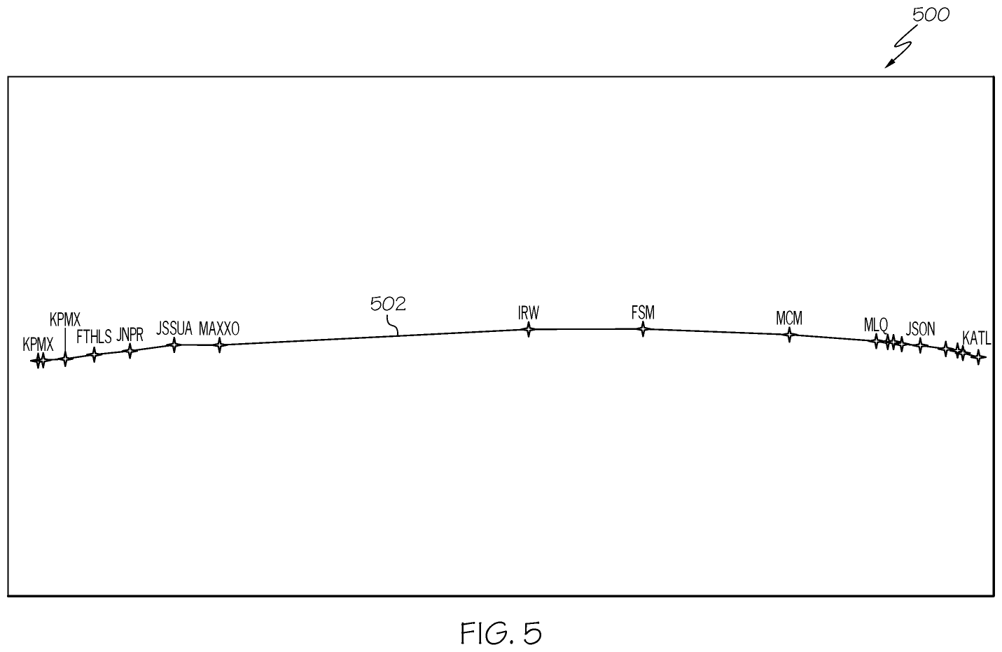

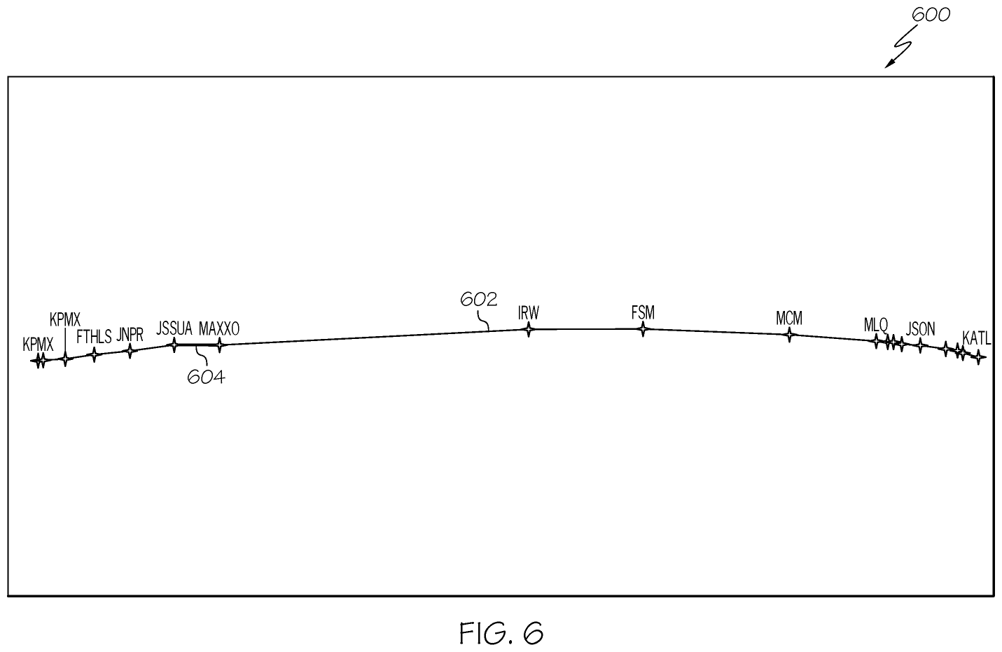

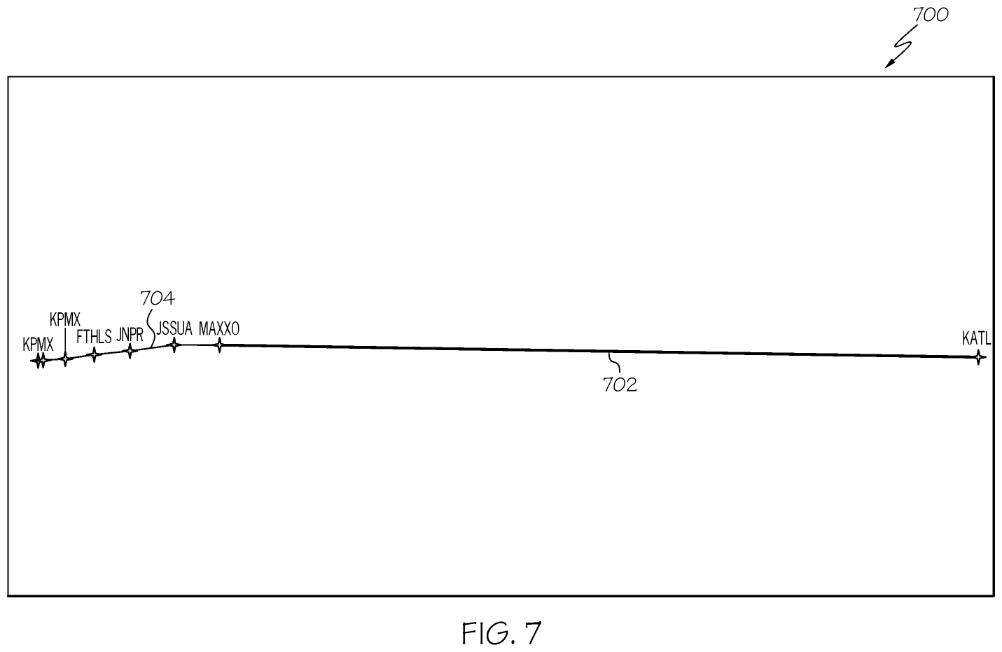

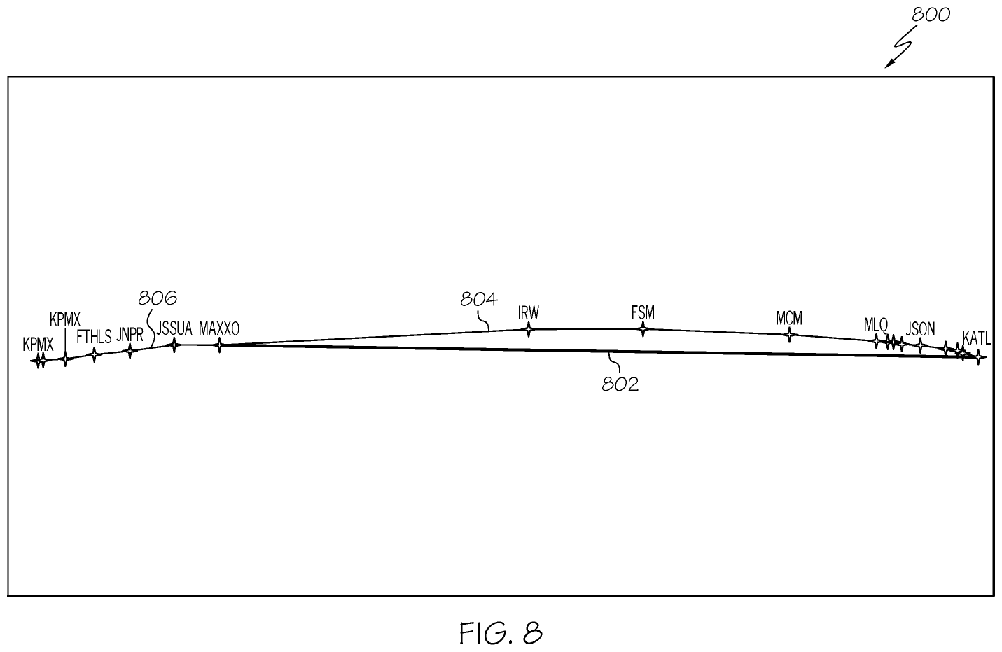

Turning now to FIG. 5, a lateral view 500 (i.e., top down view) of a flight plan 502 with multiple waypoints is shown in accordance with one embodiment. In this example, waypoints are used to divide the flight plan up into multiple segments. Turning now to FIG. 6, a lateral view 600 of a flight plan 602 is shown with a highlighted segment 604 that contains the present location of the aircraft. This highlighted segment 604 corresponds to the previously shown display with a highlighted segment 406 in FIG. 4. Turning now to FIG. 7, a lateral view 700 is shown of a flight plan 702 in which the crew has performed a bypass operation and has subsequently lost cognizance of the original flight plan. The initial flight plan 704 is shown that corresponds to the flight plans 502 and 602 shown previously in FIGS. 5 and 6. However, once the bypass flight plan 702 is executed, the downpath portion of the initial flight plan is removed. Turning now to FIG. 8, a lateral view 800 is shown of the bypass flight plan 802 with the overlaid view of the recovered flight plan 804 in addition to the initial flight plan 806. The overlaid view may be shown on the visual display system 106 and 202 shown previously in FIGS. 1 and 2. The overlaid view allows a pilot of the aircraft the option to resume flying along the recovered flight plan 804 at a later point after executing the bypass flight plan 802.

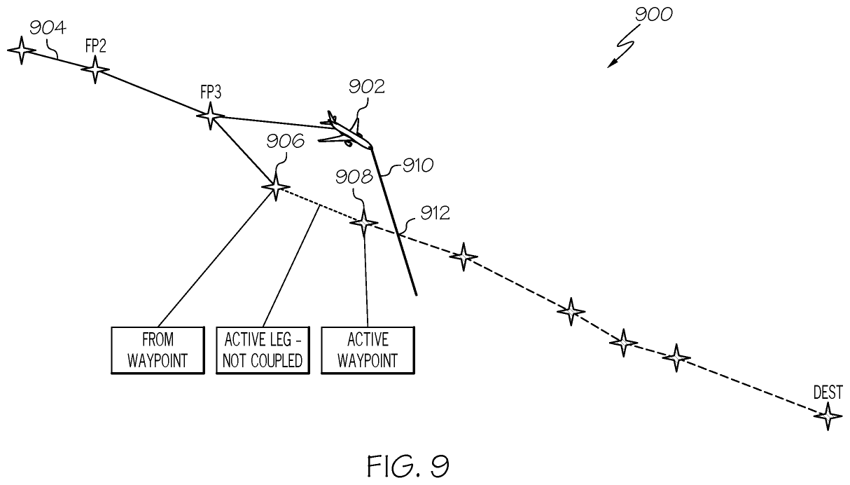

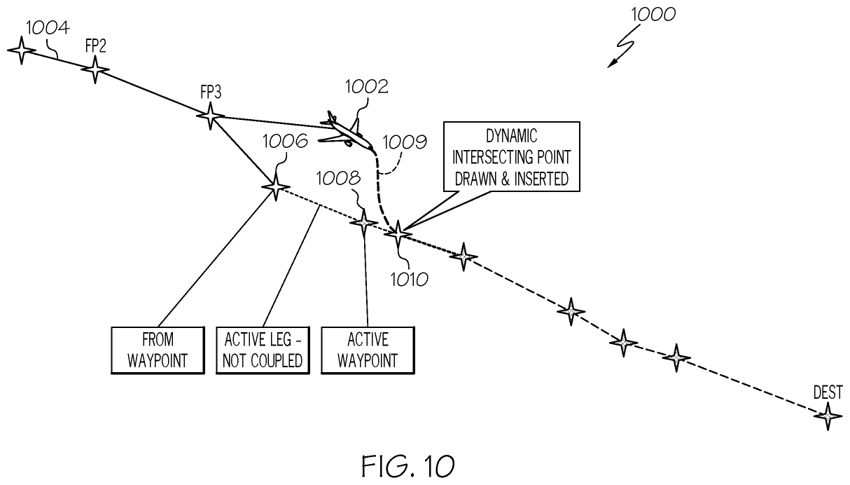

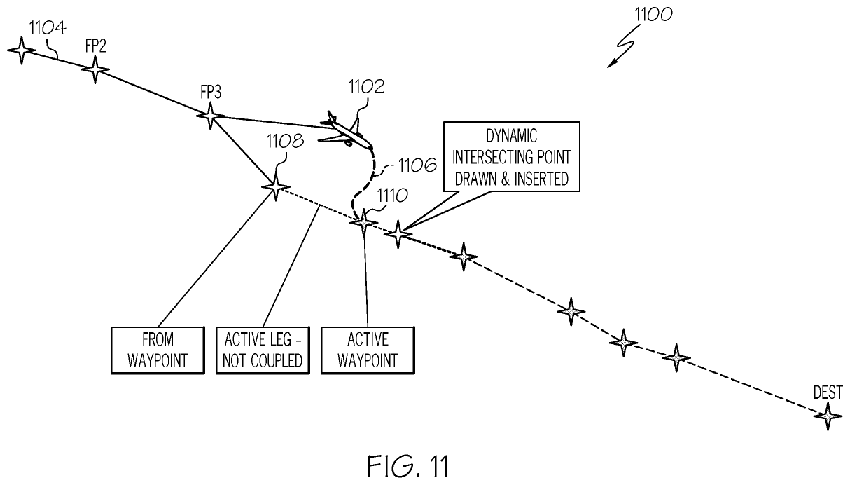

Once a pilot decides to resume flying along the recovered flight plan 804, there are several possible techniques to return to the recovered flight path. Turning now to FIG. 9, a diagram 900 is shown of a recovered flight plan in which the crew has selected a heading which intersects with the flight plan but without an indication of flight plan resumption. In this example, the aircraft 902 is shown as departing from the initial flight plan 904 and bypassing a waypoint 906. Upon attempting to return to the recovered flight plan 908, the aircraft takes a direct intercept heading 910 to an intercept point 912 with the recovered flight plan 908. In another example shown in FIG. 10, a diagram 1000 shows the aircraft 1002 has departed from the initial flight plan 1004 and bypassed a waypoint 1008. Once the aircraft 1002 decides to resume flying along the recovered flight path, the aircraft takes a heading 1009 to intercept the next downpath waypoint 1010 along the recovered flight path. In another example shown in FIG. 11, a diagram 1100 shows an alternative depiction of FIG. 10 where the aircraft 1102 has departed from the initial flight plan 1100 to bypass two waypoints 1108 and 1110. Once the aircraft decides to resume flying along the recovered flight path, the aircraft takes a heading 1106 to return to a previously bypassed waypoint 1110 along the recovered flight path.

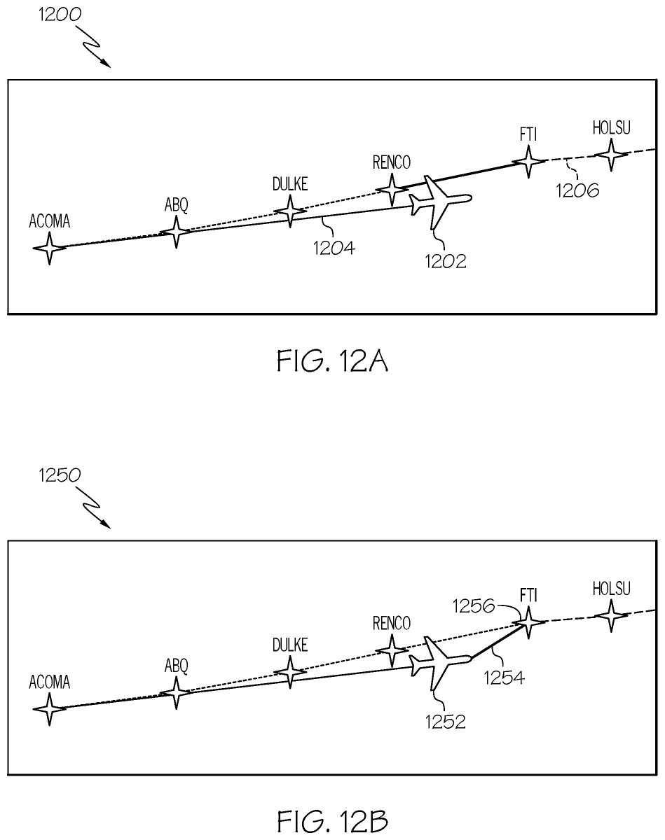

In still another example shown in FIGS. 12A and 12B, diagrams 1200 and 1250 show a recovered flight plan with a resumption without regard to the aircraft's present position. In FIG. 12A, the aircraft 1202 is on a present course 1204 that deviates from the original flight plan 1206. Once a decision is made to resume the flight plan, it is done without regard to the aircraft's 1206 present position in this example. As shown in FIG. 12B, the aircraft 1252 returns to the original flight plan 1254 by intercepting the next waypoint 1256 along the flight path. In this example, a bypassed waypoint is ignored and the aircraft directed on a heading to the next waypoint from its present position.

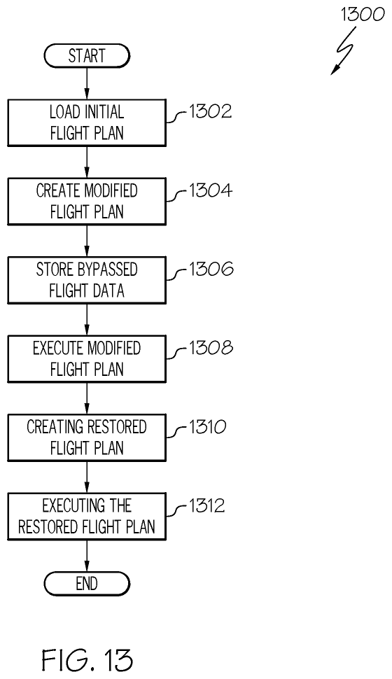

Turning now to FIG. 13, a flowchart is shown for a method for recovering flight plan data for a bypassed segment of a flight plan in accordance with one embodiment. First, an initial flight plan is loaded onto the FMS 1302 on board the aircraft. The initial flight plan includes multiple waypoints located along its path. Next, a modified flight plan 1304 is created that bypasses at least one of the waypoints located along the initial flight plan. The modified flight plan may be created as a result of instructions from air traffic control (ATC) or as a result of action by a pilot of the aircraft. For example, the ATC may instruct the aircraft to take a shortcut bypassing several waypoints in order to achieve an earlier arrival time at the destination. In other examples, the pilot may take actions on his own initiative to bypass waypoints to avoid turbulence, adverse weather, etc. The modified flight plan may be created by adding additional waypoints along the modified flight plan route or deleting waypoints along the initial flight plan. In other examples, the modified flight plan may simply bypass waypoints by flying directly to a downpath waypoint or even to an out-of-path waypoint that was not part of the initial flight plan. Finally, a modified flight plan may be created by simply flying on a new heading without regards to waypoints.

Once the modified flight plan is created 1304, the bypassed flight data that contains the bypassed waypoints located along the initial flight plan is stored 1306 in a retrievable electronic memory located on the FMS. At this point, the FMS may execute the modified flight plan 1308. After some period of time, the aircraft may want to resume flying along the initial flight plan. At this point a restored flight plan is created by retrieving the bypass flight data from the retrievable electronic memory of the FMS 1310. The restored flight plan may be created as a result of instructions from the ATC for the aircraft to resume flying along the initial flight plan or as a result of actions by the pilot of the aircraft. Once the restored flight plan is created, it is loaded and executed by the FMS 1312.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for recovering flight plan data for a bypassed segment of a flight plan onboard an aircraft, comprising:
loading an initial flight plan onto a Flight Management System (FMS) located on board the aircraft, where the initial flight plan comprises multiple waypoints located along the initial flight plan;
creating a modified flight plan that bypasses at least one of the waypoints located along the initial flight plan;
storing bypassed flight data that contains the bypassed waypoints located along the initial flight plan, where the bypassed flight data is stored in a retrievable electronic memory located on the FMS;
executing the modified flight plan with the FMS;
creating a restored flight plan by retrieving the bypassed flight data from the retrievable electronic memory and loading the restored flight plan onto the FMS; and
executing the restored flight plan with the FMS.

2. The method of claim 1, where the modified flight plan is created as a result of instructions from air traffic control (ATC).

3. The method of claim 1, where the modified flight plan is created as a result of actions by a pilot of the aircraft.

4. The method of claim 1, where the modified flight plan is created by adding additional waypoints.

5. The method of claim 1, where the modified flight plan is created by deleting waypoints.

6. The method of claim 1, where the modified flight plan is created by bypassing waypoints by flying directly to a down path waypoint.

7. The method of claim 1, where the modified flight plan is created by bypassing waypoints by flying directly to an out-of-path waypoint.

8. The method of claim 1, where the modified flight plan is created by flying on a new heading without regard to waypoints.

9. The method of claim 1, where the restored flight plan is created as a result of instructions from ATC.

10. The method of claim 1, where the restored flight plan is created as a result of actions by the pilot of the aircraft.

11. A system for recovering flight plan data for a bypassed segment of a flight plan on board an aircraft, comprising:
a navigation system located on board the aircraft, where the navigation system has a processor and a retrievable electronic memory, where the processor is programmed to,
load an initial flight plan into the navigation system located comprising multiple waypoints located along the initial flight plan,
create a modified flight plan that bypasses at least one of the waypoints located along the initial flight plan,
store bypassed flight data that contains the bypassed waypoints located along the initial flight plan in a retrievable electronic memory located on the navigation system,
execute the modified flight plan,
create a restored flight plan by retrieving the bypassed flight data from the retrievable electronic memory,
load the restored flight plan onto the navigation system, and
execute the restored flight plan; and
a visual data system that displays the restored flight plan and the the modified flight plan.

12. The system of claim 11, where the modified flight plan is created as a result of instructions from air traffic control (ATC).

13. The system of claim 11, where the modified flight plan is created as a result of actions by a pilot of the aircraft.

14. The system of claim 11, where the modified flight plan is created by adding additional waypoints.

15. The system of claim 11, where the modified flight plan is created by deleting waypoints.

16. The system of claim 11, where the modified flight plan is created by bypassing waypoints by flying directly to a down path waypoint.

17. The system of claim 11, where the modified flight plan is created by bypassing waypoints by flying directly to an out-of-path waypoint.

18. The system of claim 11, where the modified flight plan is created by flying on a new heading without regard to waypoints.

19. The system of claim 11, where the restored flight plan is created as a result of instructions from ATC.

20. The system of claim 11, where the restored flight plan is created as a result of actions by the pilot of the aircraft.
